(19) United States
(12) Patent Application Publication
(10) Pub. No.: US 2003/0187816 A1
(43) Pub. Date: Oct. 2, 2003

(54) System and method for transparent database conversion

(76) Inventor: Cary A. Jardin, San Diego, CA (US)

Correspondence Address: ARTER & HADDEN, LLP, 1100 HUNTINGTON BUILDING, 925 EUCLID AVENUE, CLEVELAND, OH, 44115-1475, US

(21) Appl. No.: 10/108,782

(22) Filed: Mar. 27, 2002

(51) Int. Cl. G06F 7/00

(52) U.S. Cl. 707/1

(57) ABSTRACT

A method and system for accomplishing transparent database translation. The architecture determines from the nature of a packet on a network the whether the packet is a database transaction. If the packet is a database transaction, it is suitably intercepted for further analysis. The packet is then suitably converted into a vendor-specific form different than the form of the intercepted packet and sent to a target vendor database server. When the new packet is created for transmission to the target database server, it is created such that it appears to the devices on the network as though it is an appropriate response to the original packet, even though the original packet was intercepted before arriving at its destination address.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE TO A “SEQUENCE LISTING”, A TABLE, OR A COMPUTER PROGRAM LISTING APPENDIX SUBMITTED ON A COMPACT DISC

Not Applicable.

### BACKGROUND OF THE INVENTION

The present invention pertains generally to database conversion, and more specifically, to method and system for transparent database conversion and migration.

Over the last 40 years, database technologies have become an integral part of corporate Information Technology (IT) infrastructure. More recently, Internet-enabled commerce and real-time information retrieval has more than quadrupled the demand of database infrastructure. Database usage is increasing exponentially, as is the amount of data stored in these databases, and the existing database application and Server platforms are often unable to sustain such growth. One reason for such inability is that the technology driving today's databases is based on technology created in the 1960's.

In addition to lack of compatibility among applications written for different vendor databases, databases are limited by the hardware on which they reside. One method of increasing database performance is to upgrade the database Server hardware. However, upgrading to a new hardware platform is almost as painful as modifying database applications to conform to a new database vendor. One method of upgrading database Servers involves increasing the number of processors in the Server. Unfortunately, increasing the number of processors does not increase performance in a linear manner. It is clear that database performance problems are not solved solely by increasing the number of processors. There are several common methods of improving database performance aside from upgrading general-purpose hardware. These methods include using specialized database hardware and optimizing database Servers. Databases are generally optimized through the use of caching and transaction routing. However, techniques for boosting database performance generally require modification to the Client or Server applications, or the replacement of hardware.

While databases all operate the same principles, their application protocols are often very different. For example, IBM DB2 clients talk to IBM DB2 servers in a proprietary application protocol, while Oracle clients talk to Oracle servers in a different proprietary application protocol, even though IBM DB2 and Oracle have similar functionality. To further complicate matters, database applications are often vendor-specific. In other words, applications written to interact with one database platform are incompatible with other database platforms. Consequently, switching from one database platform to another is costly and time-intensive.

### BRIEF SUMMARY OF THE INVENTION

The present invention disclosed and claimed herein, in one aspect thereof, comprises a method of improving network database performance. The method comprising the steps of determining whether a first network packet involves a database transaction and selectively intercepting the first network packet upon determining that the network packet involves a database transaction. The database transaction is then suitably analyzed to determine its nature, after which it is selectively translated to a vendor-specific form based on its determined nature. A new network packet is then suitably created and at least one of the source or destination addresses of the second network packet is selectively masked in order to achieve network transparency.

In another aspect thereof, the claimed invention comprises a system for translating database information from one vendor-specific form to another vendor-specific form. The system comprises a first database server, a second database server, a client and a database translator all communicatively coupled to a network. The database translator comprises a packet interrogator for determining whether packets on the network are database transaction packets, determining the source and destination addresses of the packets, and determining the nature of the database transactions. The database translator also comprises a packet interceptor for intercepting database transaction packets and a transaction accelerator for accelerating transactions between a database server and a client.

### BRIEF DESCRIPTION OF THE DRAWINGS

FIG. 1 illustrates an overall block diagram of the subject system for data packet handling to accomplish database translation in connection with the subject invention;

FIG. 2 illustrates a block diagram of the method for performing transaction conversion after intercepting a database transaction;

FIG. 3 illustrates a block diagram of the packet handling for determination of whether a data packet should be intercepted for analysis while maintaining network transparency;

FIG. 4 illustrates a block diagram for a method for performing database translation in connection with the subject invention;

FIG. 5 illustrates an overall system architecture in which the translator is disposed in a network and communicatively coupled to a Native Server, a Target Vendor Server and a Client to accomplish the database translation; and

FIG. 6 illustrates a translation from an Oracle database to a Sybase Server database.

### DETAILED DESCRIPTION OF THE INVENTION

Transparency to database applications is a very difficult and novel task. It starts by placing the current invention inside the communication channel between a database Client and Server. One method of achieving such transparency is to actively participate in the network infrastructure that connects the Client and Server. One of the most common communication protocols used to transport data from Client to Server is Ethernet. One embodiment of the present invention suitably enables an Ethernet device to sit between the Client and Server to freely route traffic between the Client and Server while translating database transactions from one database protocol to another. This is achieved by understanding the electrical impulses, packet structure, protocol, and Client and destination addresses specified in the Ethernet IEEE 802.3 specification. It should be noted that while the presently preferred embodiment is described with reference to Ethernet communication protocols, the present invention is not limited to Ethernet and is suitably applicable to any network protocol, such as token ring. It should also be noted that the Client in the present invention is suitably a database client or an application server.

An Ethernet “packet” can be defined generally as a unit of data at any layer of the Open Systems Interconnect (“OSI”) protocol stack. An OSI protocol stack is a layered set of protocols which work together to provide a set of network functions, wherein each intermediate protocol layer uses the layer below it to provide a service to the layer above. In general, OSI architecture model is a seven layer model having layers, from lowest to highest: 1) physical layer, 2) data link layer, 3) network layer, 4) transport layer, 5) session layer, 6) presentation layer, 7) application layer. The physical layer is the lowest layer and concerns electrical and mechanical connections to the network. The data link layer splits data into frames for sending on the physical layer, receives acknowledgement frames, and performs error checking so that frames not received correctly can be re-transmitted. Thus, it provides an error-free virtual channel to the network layer. The data link layer is split into an upper sublayer, Logical Link Control (“LLC”), and a lower sublayer, Media Access Control (“MAC”). The lower sublayer, the MAC, differs for various physical media and acts as the interface to the physical layer. The MAC layer is responsible for moving data packets to and from one node to another. The LLC, in turn, presents a uniform interface to the network layer controlling frame synchronization, flow control and error checking. The network layer then determines the routing of packets of data from sender to receiver.

Within an Ethernet packet, the preferred embodiment of the present invention statefully understands the flow of traffic from the Client to the Server. Depending on the Ethernet network topology in which the Server exists, the current invention identifies Ethernet packets with a destination Media Access Control (MAC) address, the hardware address of a device, which corresponds to a Server MAC address. In this way, all Ethernet packets bound for the Server (ingress) can be intercepted for further analysis. Likewise the current invention identifies all Ethernet packets with a destination MAC address associated with either the Client or egress IP router. In the case of IP routers, the egress MAC address are suitably identified as configuration parameters. Therefore, all outbound (egress) packets can be inspected for further processing. It is within the embodiment of the current invention to play an active role in the Ethernet communication between the Client and Server. In this manner, the current invention suitably modifies the ingress and egress packets to facilitate transparent Ethernet functionality. The determination to modify ingress or egress packets is suitably made upon the contextual knowledge higher-level communication protocol encapsulated within the data payload of the Ethernet packet.

A communication protocol such as TCP/IP suitably overlays the Ethernet packet and provides a reliable data transportation mechanism between a Client and a Server. After the Ethernet traffic is classified as traffic between a Client and database Server, the data contained within the Ethernet packet is framed into TCP/IP (specifically it is IP framed) to determine the nature of the traffic. Within the IP framing of the Ethernet packet exist Client and Server port numbers used to identify the communication channel between the Client and Server. Specifically, the Client opens a connection toward the Server by selecting a connection-unique Client port and selecting a service-unique Server port. The presently preferred embodiment of the current invention utilizes the Server port to determine the intent of the Client connection request.

For example, a Client request with a Server port number of 80 would correspond to an HTTP request. The current invention suitably contains a set of known port numbers for various database services. From the framed IP traffic and a determined match to a known database Server service port, the current invention suitably determines the nature of the current Server-bound Ethernet packet so that a translator can perform translation on the intercepted packet. During the course of intercepting and translating transaction requests, the translator suitably intercepts packets sent from a Server to a Client. In such instances, the current invention suitably assumes the IP and MAC address of the Server ingress packets, as well as assume the IP address of the requesting Client and the MAC address of the Client or egress router (based on the location of the Client on either a local or remote Ethernet network).

The assumption of MAC addresses allows the present invention to achieve transparency. Once Ethernet and IP transparency has been achieved, the current invention appears to the Server as though it is the Client, and appears to the Client as though it is the Server. This transparency suitably permits the present invention to convert database transactions from one database type to another in a transparent, minimally obtrusive manner.

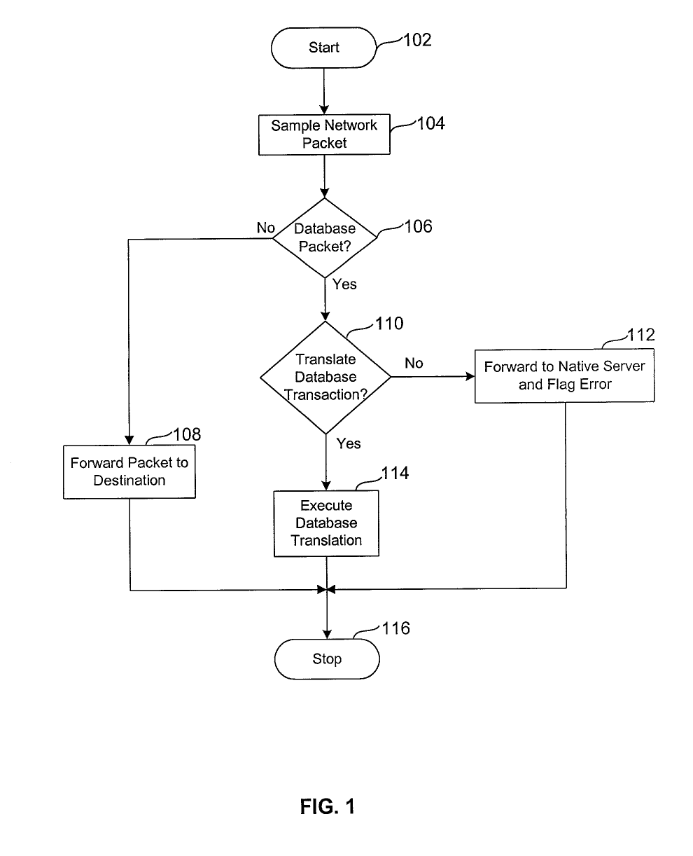

Turning to FIG. 1, an overall block diagram of the subject system for data packet handling to accomplish transaction conversion and database migration in connection with the present invention is disclosed. The basic flow commences at start block 102, from which progress is made to process block 104 at which point a sample packet is taken. The system suitably samples every network data packet or a subset of network data packets. A determination is made at decision block 106 whether the sampled packet includes data representative as to whether the subject packet is a database packet. This determination is suitably accomplished by analysis of a packet header, content of the subject packet, or other suitable criteria as dictated by the particular database application.

A negative determination at decision block 106 causes progress to process block 108. At this point, the packet is forwarded along to an appropriate destination as no processing is required. Flow progresses and the system proceeds to stop at termination block 116.

A positive determination at decision block 106 causes progression to decision block 110. At this point, a database packet from an associated Client has been determined to be present. A determination is then made at decision block 110 whether the database packet can be translated or converted.

A negative determination at decision block 110 causes progression to process block 112 wherein the subject packet is forwarded to the Native Server for processing and an error is returned. The Native Server is suitably the Server running the database application to which the Client is associated as in a network database environment.

A positive determination at decision block 110 causes progression to process block 114 wherein database translation or conversion is executed using information contained in the subject packet, as will be detailed hereinbelow. Flow then progresses from both process blocks 112 and 114 to termination block 116 where the system proceeds to stop.

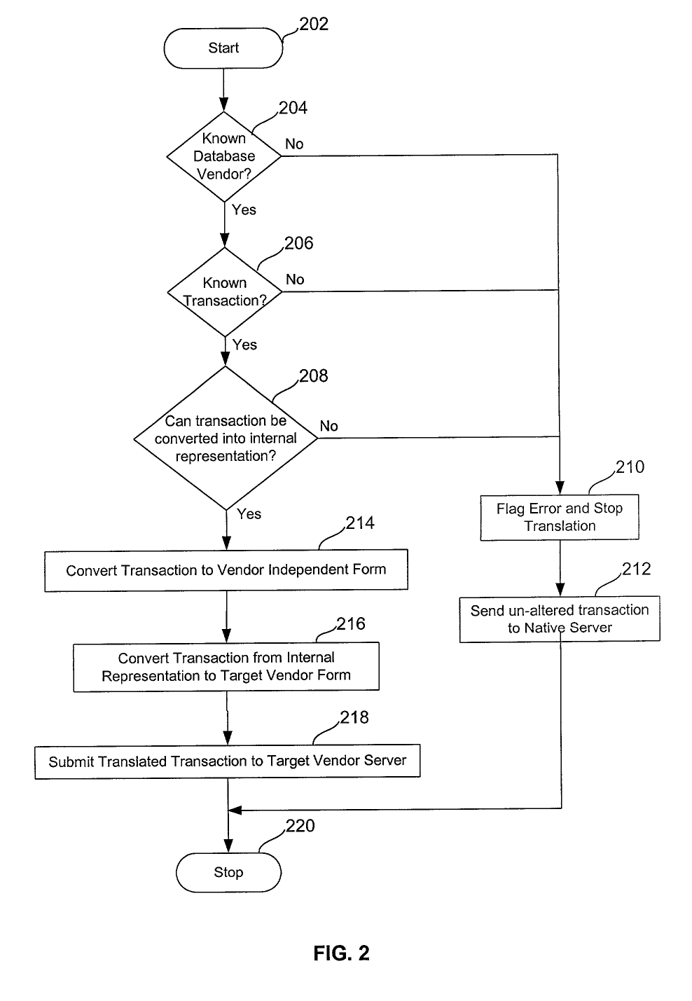

Turning now to FIG. 2, depicted is a block diagram illustrating the process of converting from one database form to another a packet intercepted during transmission from a Client to the Native Server. The overall flow commences at start block 202, from which progress is made to decision block 204, at which point a determination is made whether the intercepted transaction involves a known database vendor. A negative determination at decision block 204 causes progression to process block 210 at which point translation is stopped and an error is returned. Progression then continues from process block 210 to process block 212 at which point the unaltered transaction is sent to the Native Server. Progression then flows to termination block 220.

A positive determination at decision block 204 causes progression to decision block 206 where a determination is made whether the intercepted transaction is a known transaction. A negative determination at decision block 206 causes progression to process block 210 at which point translation is stopped and an error is returned. Progression then continues from process block 210 to process block 212 at which point the unaltered transaction is sent to the Native Server. Progression then flows to termination block 220.

A positive determination at decision block 206 causes progression to decision block 208 where a determination is made whether the transaction can be converted into a vendor-independent form. A negative determination at decision block 208 causes progression to process block 210 at which point translation is stopped and an error is returned. Progression then continues from process block 210 to process block 212 at which point the unaltered transaction is sent to the Native Server. Progression then flows to termination block 220.

A positive determination at decision block 208 causes progression to process block 214 at which point the transaction is converted into a vendor-independent form. The vendor-independent form is suitably an internal representation of the database transaction. Flow then progresses to process block 216 at which point the transaction, now in vendor-independent form, is converted to a vendor specific form corresponding to a Target Vendor Server. The Target Vendor Server is suitably a database Server that uses a different protocol than the Native Server.

Following conversion at process block 216, progression flows to process block 218 wherein the translated transaction is submitted to the Target Vendor Server, after which progression flows to termination block 220.

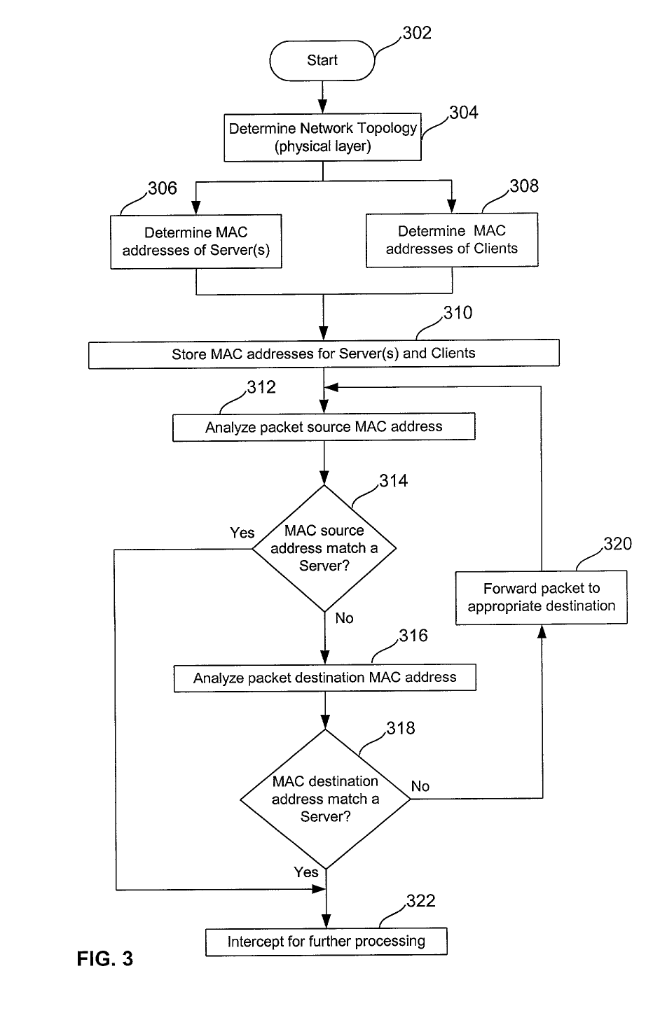

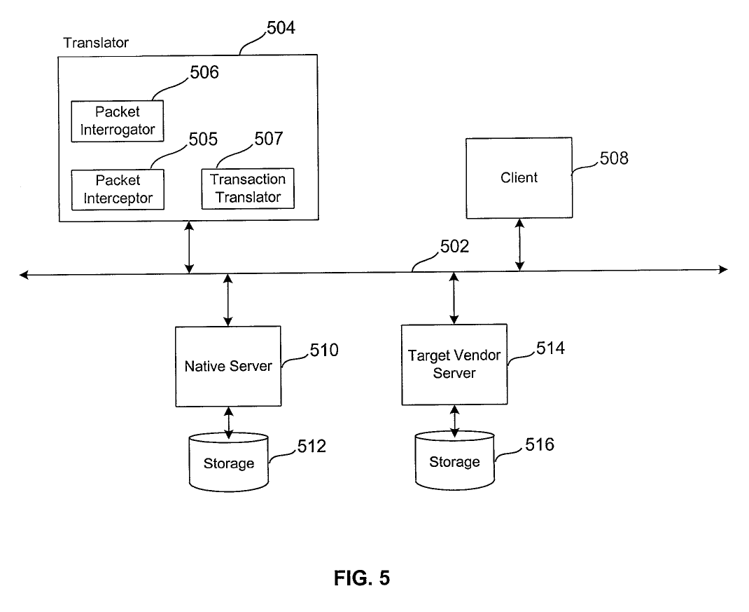

Turning now to FIG. 3, depicted is a block diagram of packet handling for determination of whether a data packet should be intercepted for analysis and conversion. The basic flow commences at start block 302, from which progress is made to block 304 at which point the type of network topology is examined. In particular, the physical layer of the network is suitably examined in process 302 so that the packet can be properly analyzed. Flow then progresses to process blocks 306 and 308 where the MAC addresses of the Server(s) and Client(s) are determined, respectively. Progress then flows to process block 310 where the MAC addresses of the Server(s) and Client(s) are stored. The MAC addresses are suitably stored locally by the translator or on any storage device connected to the network transport system as shown in FIG. 5.

Progression continues to process block 312 at which point the packet source MAC address is analyzed. For each packet sampled in process 104 of FIG. 1, the source MAC address is suitably analyzed in process block 312, after which flow progresses to decision block 314. At decision block 314, a determination is made whether the MAC source address of the sampled packet matches a database Server MAC address determined in process 306 and stored in process 310. A positive determination at decision block 314 means that the packet is a database transaction packet and leads to a progression to process block 322 where the packet is intercepted for further processing.

A negative determination at decision block 314 causes progression to process block 316 wherein the sampled packet destination MAC address is analyzed. Flow progresses to decision block 318 wherein determination is made whether the MAC destination address of the sampled packet matches a database Server MAC address determined in process 306 and stored in process 310. A positive determination at decision block 318 means that the sampled packet is a database transaction packet and flow therefore progresses to process block 322 where the packet is intercepted for further processing.

A negative determination at decision block 318 causes progression to process block 320 wherein the sampled packet is forwarded to its appropriate destination without further processing, as it is not a database transaction packet. Flow then progresses back to process 312 where the next sampled packet's MAC source address is analyzed.

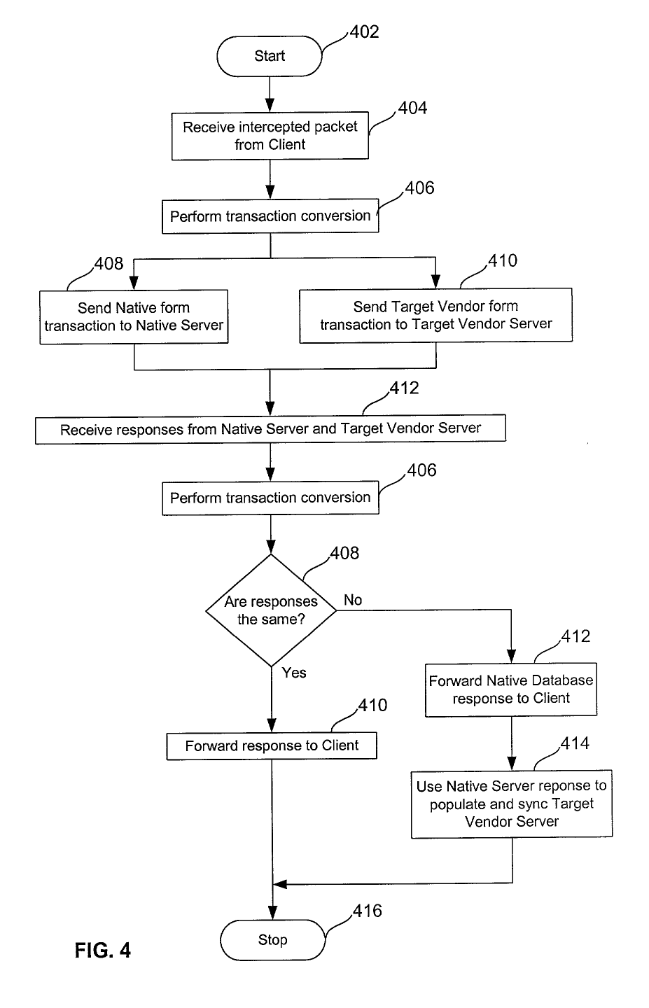

Turning now to FIG. 4, depicted is a block diagram for a method for performing database translation in connection with the subject invention. The basic flow commences at start block 402, from which progress is made to process block 404 at which point a packet that was intercepted from a Client is received. Progress is then made to process block 406 wherein transaction conversion is performed on the intercepted packet. The transaction is suitably converted into a vendor-independent form, which is then suitably converted into a Target Vendor form.

Progression continues to process blocks 408 and 410 wherein the transaction is sent in its Native form to the Native Server and in the converted Target Vendor form to the Target Vendor Server. Transparency techniques as described above are preferably used so that the translator appears to the Native Server as the Client. The Native Server and the Target Vendor Server suitably respond to the requests and the translator suitably receives the requests. In order to receive the requests from the Native Server, the translator suitably assumes the IP address of the requesting Client and the MAC address of the Client or egress router (based on the location of the Client on either a local or remote Ethernet network). In addition, the translator suitably sends requests to the Target Vendor Server with the IP and MAC addresses of the Client or of the translator itself. Thereafter, the translator suitably either intercepts responses from the Native Server and Target Vendor Server intended for the Client (or router), or receives responses intended for the translator.

After receipt of responses from both the Native Server and the Target Vendor Server, progression flows to process block 406 wherein the translator suitably converts the responses into vendor-independent form if necessary to facilitate their comparison. Flow then continues to decision block 408 where a determination is made whether the response from the Native Server is the same as the response from the Target Vendor Server. A positive determination at decision block 408 means that both responses are the same and that both databases returned the same results, which causes progression to process block 410 where the returned response is sent to the Client. Because both responses are the same, either response is suitably sent to the Client.

Assuming that no errors occurred in converting the transaction sent by the Client, a negative determination at decision block 408 means that the translator queried different data on the Native Server then it did on the Target Vendor Server. This determination causes progression to flow to process block 412, at which point the Native Database response is forwarded to the Client. When the response is sent to the Client, it is important that the packet appear to the Client that it originated from the Server. Therefore, the translator suitably either forwards the Server response directly to the client or sends a suitable response to the Client masked as a Server response. After a response is sent to the Client, the process ceases at termination block 416.

Progression then flows to process block 414 wherein the response received from the Native Server is used to populate the Target Vendor Server and synchronize the data stored on the Target Vendor Server with that stored on the Native Server. Any synchronization and data coherency technique is suitably used to alter the data stored on the Target Vendor Server. After synchronizing the Servers, progression flows to block 416 at which point the process terminates.

Turning next to FIG. 5, a database network illustrative of a LAN or WAN environment in which a preferred database translation embodiment is provided. A translator 504 comprises a packet interrogator 506 that provides a platform to accomplish the functionality noted in connection with FIGS. 1-4 above. The translator is in data communication with a data transport system 502, suitably comprised of physical and transport layers such as illustrated by a myriad of conventional data transport mechanisms such Ethernet, Token-Ring™, 802.11(b), or other wire-based or wireless data communication mechanisms as will be apparent to one of ordinary skill in the art.

The data transport system 502 is also placed in data communication with a Native Server, a representative one of which is illustrated by Native Server 510, which database Server comprises a storage subsystem 512. In addition, placed in data communication with data transport system 502 is a Target Vendor Server 514 comprising internal storage 516. The Native Server 510 and Target Vendor Server 514 are suitably any Server for accommodating selective query support, selective data access, data archiving, and the like, as will be appreciated to one of ordinary skill in the art. Preferably, the Native Server 510 and Target Vendor Server 512 are database servers operating on different database platforms. One or more Clients, such as representative Client 508, are also placed, or selectively placed, in data communication with the data transport system 502. The Client 508 is preferably configured to interact with Native Server 510 as will be appreciated by one who is skilled in the art. It should be noted that a Client 508 is suitably a database client or an application server. Thus, a data path between Native Server 510 and the one or more clients, such as representative Client 508, is in shared data communication with the Translator 504. Thus, the Translator 504 suitably intercepts data traffic between at least one database Server and at least one Client. The traffic is suitably intercepted by a Packet Interceptor 505 and analyzed by a Packet Interrogator 506 to determine its nature. The ability to determination of the nature of the network packet on data transport system allows the Translator to function transparently. The intercepted packet is then selectively translated by the Packet Translator 507.

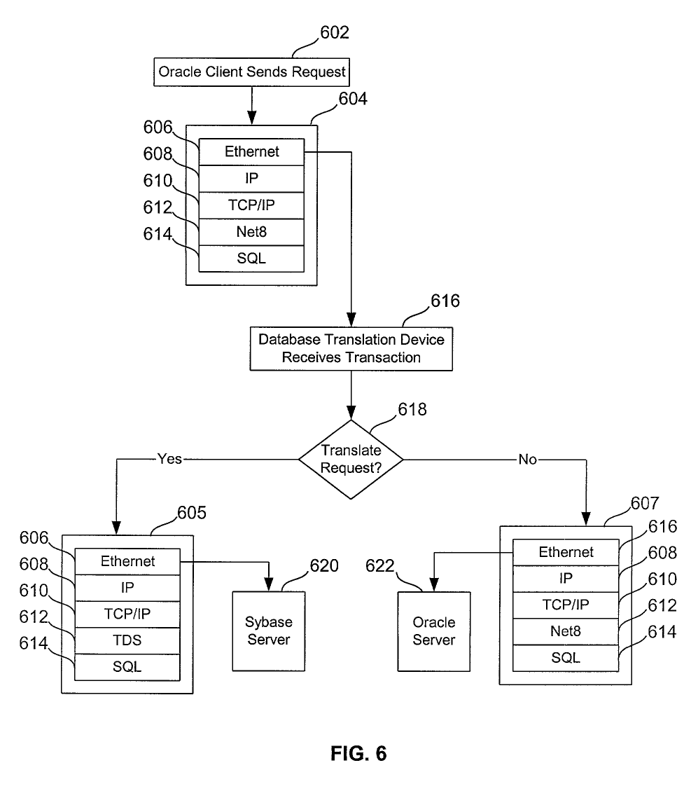

Turning next to FIG. 6, a database diagram illustrating the differences in network packets before and after conversion is provided. As shown, the diagram references the translation or conversion of a packet generated by an Oracle Client representing a request for an Oracle Server 622 that is converted to a request for a Sybase Server 620. When the Oracle Client sends a request as in process block 602, a packet 604 is generated and preferably sent across a data transport network upon which a translation device resides. The data transport network is suitably an Ethernet network, as illustrated by Ethernet layer 606. The network packet 604 suitably comprises a physical layer, a data link layer, a network layer, a transport layer, a session layer, a presentation layer, and an application layer, as will be understood by those skilled in the art. Packet layers 606-614 illustrate the nature of the packet 604. In particular, the Oracle Client generates packets with Net8 612 and SQL 614 protocols.

During its transmission across a data transport network, the packet 604 is suitably intercepted by the database translation device at process block 616. The translation device then suitably interrogates the packet 604 to determine at decision block 618 if it can translate into Sybase the request associated with packet 604.

A positive determination at decision block 618 means that the translator will convert the packet 604 to packet 605. As shown, the translated packet 605 comprises information relative to the TDS 612 and SQL 614 protocols, as compared to the original packet's 604 Net8 612 and SQL 614 protocols. The translator then sends the converted packet 605 to the Sybase Server 620.

A negative determination at decision block 618 means that the translator will not convert the packet 604 into another form. Therefore, the packet 607 sent to the Oracle Server 622 by the translator is suitably of the same form as original packet 604. Packet 607 is suitably the same packet as packet 604, or a modified version of packet 604, but preferably maintains the same information relative to the request generated by the Oracle Client at process block 602.

Although the preferred embodiment has been described in detail, it should be understood that various changes, substitutions, and alterations can be made therein without departing from the spirit and scope of the invention as defined by the appended claims. It will be appreciated that various changes in the details, materials and arrangements of parts, which have been herein described and illustrated in order to explain the nature of the invention, may be made by those skilled in the area within the principle and scope of the invention as will be expressed in the appended claims.

What is claimed is:

1. A method of translating database transactions to a desired vendor-specific form comprising the steps of:
determining whether a first network packet involves a database transaction;
selectively intercepting the first network packet upon determining that the network packet involves a database transaction;
determining the nature of the database transaction;
selectively translating the database transaction to a desired vendor-specific form based upon the determined nature of the database transaction;
creating a second network packet; and
selectively masking at least one of the source and destination addresses of the second network packet based upon the nature of the database transaction.

2. The method of claim 1, wherein the step of translating the database transaction comprises the steps of:
converting the database transaction into a vendor-independent form; and
converting the database transaction from the vendor-independent form into the desired vendor-specific form.

3. The method of claim 1 wherein the step of determining whether a first network packet involves a database transaction comprises the step of analyzing at least one of the packet's source and destination addresses.

4. The method of claim 3 wherein the source and destination addresses are Media Access Control addresses.

5. The method of claim 1 further comprising the step of determining if the database transaction involves a known database vendor.

6. The method of claim 1 further comprising the step of determining if the database transaction is a database transaction of a known type.

7. The method of claim 1 further comprising the step of determining whether the database transaction can be converted into a vendor-independent form.

8. The method of claim 1 further comprising the steps of:
sending two database transaction packets, each of a different vendor-specific form, each comprising the same transaction; to a first database server and a second database server, respectively;
receiving responses from the first server and the second server;
determining if the received responses are the same; and
synchronizing the data stored on the first server with that stored on the second server.

9. A system for translating a database from one vendor-specific database form to another vendor-specific database form, comprising:
a packet interceptor for intercepting database transaction packets sent from a client to a database server;
a packet interrogator for interrogating database transaction packets to determine the nature of the database transactions; and
a transaction translator for translating transactions from a first vendor-specific form to a second vendor specific form.

10. The system of claim 9 wherein the packet interrogator further determines whether packets on the network are database transaction packets.

11. The system of claim 9 wherein the packet interrogator further determines the source and destination addresses of the packets.

12. The system of claim 9 wherein the system appears as a client to a server and as a server to a client.

13. The system of claim 12 wherein the system assumes the IP address of a client.

14. The system of claim 12 wherein the system assumes the IP address of a server.

15. The system of claim 9, further comprising a means for comparing responses from a first and second server.

16. The system of claim 10, further comprising a means for synchronizing the databases of the first server and the second server.

17. The system of claim 9 wherein the network is an Ethernet network.

18. A system for translating database transactions to a desired vendor-specific form comprising:
a means for determining whether a first network packet involves a database transaction;
a means for selectively intercepting the first network packet upon determining that the network packet involves a database transaction;
a means for determining the nature of the database transaction;
a means for selectively translating the database transaction to a desired vendor-specific form based upon the determined nature of the database transaction;
a means for creating a second network packet; and
a means for selectively masking at least one of the source and destination addresses of the second network packet based upon the nature of the database transaction.

19. The system of claim 16 further comprising:
a means for receiving responses from the first server and the second server;
a means for determining if the received responses are the same; and
a means for synchronizing the data stored on the first server with that stored on the second server.

20. The system of claim 19, further comprising:
a means for converting the database transaction into a vendor-independent form; and
a means for converting the database transaction from the vendor-independent form into the desired vendor-specific form.
